(19) United States
(12) Patent Application Publication
(10) Pub. No.: US 2008/0022198 A1
(43) Pub. Date: Jan. 24, 2008

(54) System and Method for Adding Proper Names and Email Addresses to a Spell Check Definition List

(76) Inventor: Brian Lee King, Apex, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/458,481

(22) Filed: Jul. 19, 2006

(51) Int. Cl. G06F 17/00; G06F 15/16

(52) U.S. Cl. 715/257; 709/206

(57) ABSTRACT

A system, method, and program product is provided for spell checking a document. Proper names are retrieved from an address book and these names are added to a temporary dictionary. In addition, email addresses and additional names can be added from additional data sources as indicated by a user. The temporary data store is provided to a spell check process that treats the proper names and email addresses stored in the temporary data store as correctly spelled words. After the spell check completes, the temporary data store is discarded. Other embodiments are also disclosed.

### BACKGROUND OF THE INVENTION

1. Technical Field

The present invention relates in general to a system and method for adding words to a spell check definition list. In particular, the present invention relates to a system and method that adds proper names and email addresses to a spell check definition list such as a temporary dictionary.

2. Description of the Related Art

Spell check utilities are commonly used in association with computer software programs to assist users with checking for correct spelling of words in documents or messages that the user has created with the software program. For example, a user may create an email message with an email software program, and then the user may check the spelling of the words in the body of the email message with an email spell check utility. When the spell check utility identifies an incorrectly spelled word within the email message, the user is notified and the user is provided a list of correctly spelled words from which to choose in order to replace the incorrectly spelled word. The list of correctly spelled words are words that the spell check utility has identified as words that the user may have intended to enter into the email message.

Unfortunately, even if a proper name has been spelled correctly within an email message or other document, spell check utilities often identify proper names as being words that have been spelled incorrectly. Given that there are so many different proper names in cultures from around the world, it would be unreasonable for a spell check utility to include all possible proper names in a single spell check dictionary of correctly spelled words.

To exacerbate the problem, in addition to the spell checker deficiency of failing to identify unfamiliar proper names as being spelled correctly, with the increased popularity of email, the spell checker may also identify unique email addresses as incorrectly spelled words. For example, in the body of an email message, a correctly spelled email address may be identified by the spell checker as being an incorrectly spelled word.

A spell checking utility consumes valuable resources if the utility identifies correctly spelled words such as proper names and/or email addresses as being incorrectly spelled. Among other things, this wasteful consumption of system resources and user time causes the system and user to be inefficient. Further, when the spell checker is used, a user could become frustrated when repeatedly delayed by the spell checker identifying proper names and email addresses as misspelled words. Thus, the user may avoid operating the spell checker utility when creating a document that includes proper names or email addresses. As a result, the user may avoid the use of the spell checking utility altogether, in which case misspelled words might be included in the body of email messages. The inclusion of misspelled words in email messages may result in recipients, such as customers or clients, having a poor opinion of the user's work product.

What is needed, therefore, is a system and method that uses common proper names, email addresses, and/or customer names when spell checking a message such as, for example, an email message. Furthermore, what is needed is a system and method that extracts proper names and email addresses from an address book or other data source and uses these proper names and email addresses as correctly spelled words when spell checking the body of the email message.

### SUMMARY

It has been discovered that the aforementioned challenges are resolved using a system, method, and program product that retrieves proper names from one or more data sources that are related to a document in which the spelling of words in the document are to be checked. At least one of the data sources from which correctly spelled words are retrieved is an address book.

When spell checking a body of an email message, the spell checking compares the words in the email body to the correctly spelled words. The correctly spelled words include proper names that were retrieved from the data sources, including the address book. The spell checking also includes reporting any misspelled words in the email body.

In one embodiment, the method includes retrieving settings from a configuration file, where each of the settings corresponds to a data source. Each data source is accessed based on the retrieved configuration file settings. In one embodiment, at least one of the data sources is accessed over a network. In addition to the address book, other examples of data sources include a buddy list, an instant messaging list, an email recipient area of an email message, a list of common proper names, and a customer names list. When a data source is accessed, words from the accessed data source are added to a temporary data store. Examples of the types of words that are added to the temporary data store include proper names and email addresses. The temporary data store is provided to a spell check process. In addition to a standard dictionary of correctly spelled words, the spell check process also uses the correctly spelled words included in the temporary data store. After the spell check completes, the user is notified of misspelled words found in the email body, and the temporary data store is discarded. However, using the aforementioned method, the proper names and email addresses that were retrieved will not be flagged as being misspelled words.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing general relationships between data stores that serve as possible sources of correctly spelled words;

FIG. 2 is a diagram showing an embodiment of general relationships between data stores used by an email spell check routine;

FIG. 3 is a flowchart showing steps taken to add words to a temporary dictionary to perform the spell checking of an email message;

FIG. 4 is a flowchart showing further steps taken to add names to the temporary dictionary;

FIG. 5 is a flowchart showing another embodiment of steps taken for accessing the data stores to create the temporary dictionary; and

FIG. 6 is a block diagram of an information handling system in which the processes described herein may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

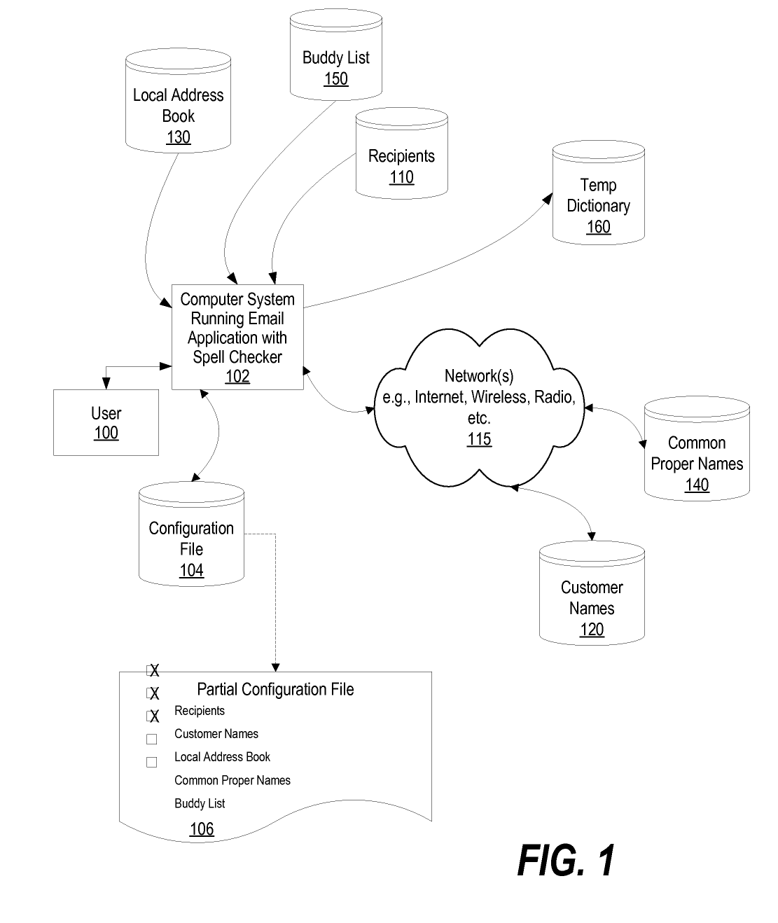

FIG. 1 is a diagram showing general relationships between data stores that serve as possible sources of correctly spelled words. User 100 interacts with computer system 102 that is running a spell check utility to check for correct spelling of words in an email message. Computer system 102 has access to a configuration file 104 that is configured to indicate which data stores that user 100 has designated as data stores for the spell check utility to access.

A partial configuration file 106 is illustrated to show an example where the configuration file 104 indicates three different data stores to be accessed. A recipient data store 110 is illustrated that contains names of recipients of, for example, an email that is being prepared by user 100 using computer system 102. Recipient data store 110 is illustrated as being directly accessible by computer system 102. However, as demonstrated by network 115, data stores are not always directly accessible by computer system 102. For example, customer names data store 120 is illustrated as being accessible by computer system 102 across network 115. On the other hand, local address book data store 130 is illustrated as being directly accessible by computer system 102. As FIG. 1 illustrates, each data store can be either directly accessible or accessible over network 115 that connects computer system 102 with other computers and data stores.

In the example shown, partial configuration file 106 does not show either common proper names data store 140 or buddy list data store 150 as being selected. However, user 100 can update configuration file 104 and choose to select these data sources. As illustrated, common proper names data store 140 is depicted as being accessible across network 115. However, any data source including common proper names data store 140, can be directly accessible (e.g., by copying the data source to a local nonvolatile storage area). Likewise, data stores, such as buddy list data store 150, that are shown as being directly accessible can be made remotely accessible (e.g., by copying the data source to a remote nonvolatile storage area).

Regardless of which data store is being accessed, if a word such as a proper name is located in the data store, the word is added to temporary dictionary 160. Temporary dictionary 160 is available for the purpose of reducing the number of errors that the spell check routine encounters when reporting incorrectly spelled words. In certain embodiments, temporary dictionary 160 is discarded when the spell check routine that uses temporary dictionary 160 completes. In other embodiments, temporary dictionary 160 is merely replaced with another temporary dictionary when the spell check routine completes. In another embodiment temporary dictionary 160 is actually a stream of data (words) that is passed to the spell checking routine prior to spell checking the user's email message.

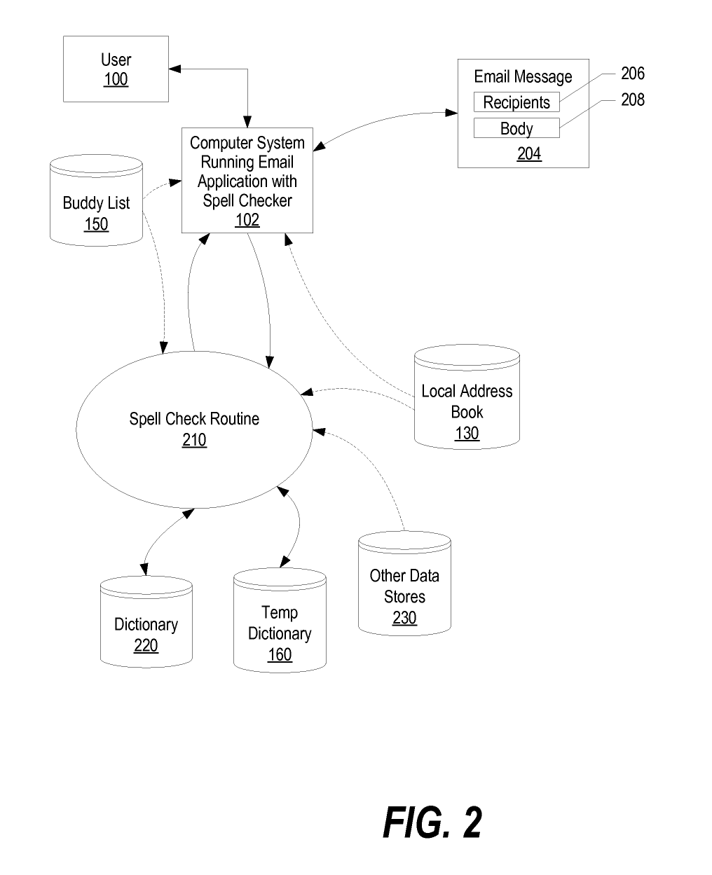

FIG. 2 is a diagram showing an embodiment of general relationships between data stores used by an email spell check routine. In this embodiment, user 100 uses computer system 102 to interact with an email application running on the computer system. The email application is used to create an email message 204 that includes both a recipient area 206 and a message body 208. The recipient area 206 includes a list of proper names and email addresses that identifies the individual recipients to which the email message 204 is intended to be sent. The email body 208 includes the words that are intended to be read by recipients of the email message 204.

The email application calls spell check routine 210 to check for the correct spelling of words in the email message body 208. The spell check routine 210 is illustrated as accessing a standard spell check dictionary 220, as well as the temporary dictionary 160 where proper names are stored temporarily. In one embodiment, the words of the temporary dictionary 160 are collected from the recipient area 206 of the email message 204 and may also be gathered from the local address book data store 130 and/or buddy list data store 150. Further, correctly spelled words for the spell check routine 210 are accessed from other data stores 230 that are read, either directly or remotely, by spell check routine 210.

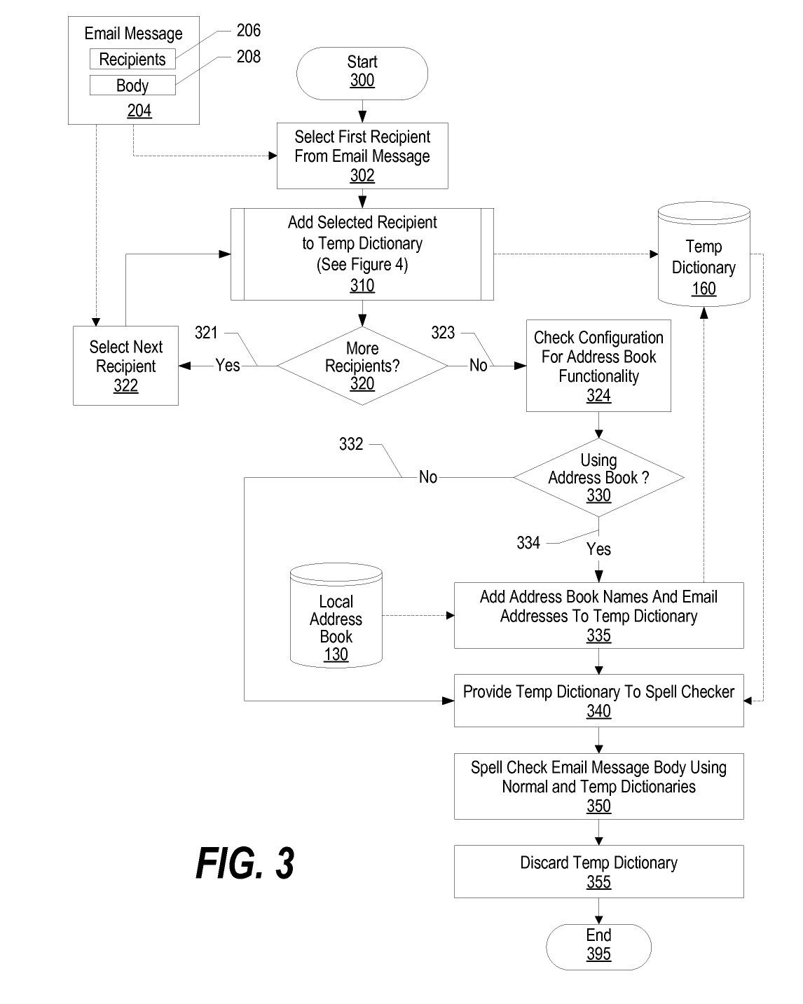

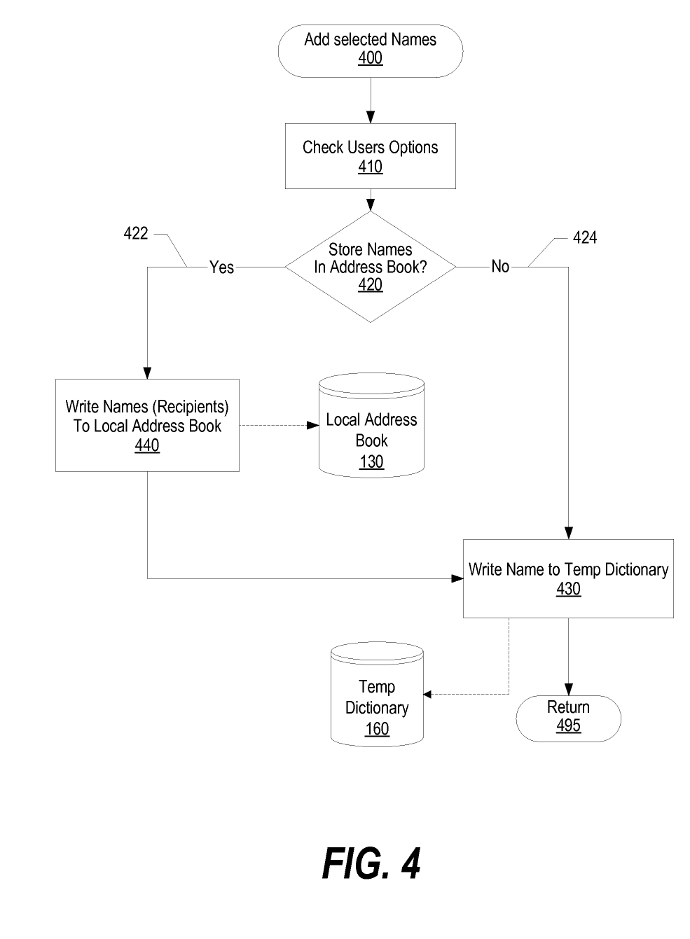

FIG. 3 is a flowchart showing steps taken to add words to a temporary dictionary to perform the spell checking of an email message. The spell checking is performed on an email message such as email message 204. Spell check processing commences at 300, whereupon, at step 302, processing selects a first recipient from email message 204. The selected recipient is added to temporary dictionary 160 at predefined process block 310 (see FIG. 4 and corresponding text for processing details of predefined process 310).

After adding the first recipient to temporary dictionary 160, a determination is made as to whether more recipients are available in the email message (decision 320). If more recipients are available, decision 320 branches to “yes” branch 321 whereupon, at step 322, the next recipient is selected from the email message and, processing loops back to predefined process 310. This looping continues until no more recipients are available in the email message, at which time decision 320 branches to “no” branch 323.

At step 324, processing checks the configuration file (see configuration file 104 shown in FIG. 1 for an example) to determine whether an address book is being used (decision 330). If an address book such as local address book 130 is being used to find proper names to be checked by the spell check routine, decision 330 branches to “yes” branch 334 whereupon, at step 335, address book names and email addresses are retrieved from local address book 130 and are added to temporary dictionary 160. On the other hand, if configuration file 104 indicates that that local address book 130 is not being used, decision 330 branches to “no” branch 332 bypassing step 335. At step 340, processing provides temporary dictionary 160 to the spell check routine.

At step 350, spell check processing performs spell checking on the email message body using both the standard (or normal) spell check dictionary and temporary dictionary 160 whereupon temporary dictionary 160 is discarded at step 355 and processing ends at step 395. In one embodiment, temporary dictionary 160 is a data stream that is provided to the spell check routine (e.g., as a parameter of words to ignore).

FIG. 4 is a flowchart showing further steps taken to add names to the temporary dictionary. Adding the name of a selected recipient commences at 400, whereupon processing checks user options regarding the selected recipient from email message 204 at step 410. If the user has chosen to have retrieved names added to an address book, such as local address book 130, decision 420 branches to “yes” branch 422 whereupon, at step 440, the recipient names are written to the local address book 130. In addition, the recipient's email addresses can also be written to local address book 130. On the other hand, if the names are not to be stored in local address book 130, decision 420 branches to “no” branch 424 bypassing step 440.

At step 430, the name is written to temporary dictionary 160. Processing then returns to the calling process at 495.

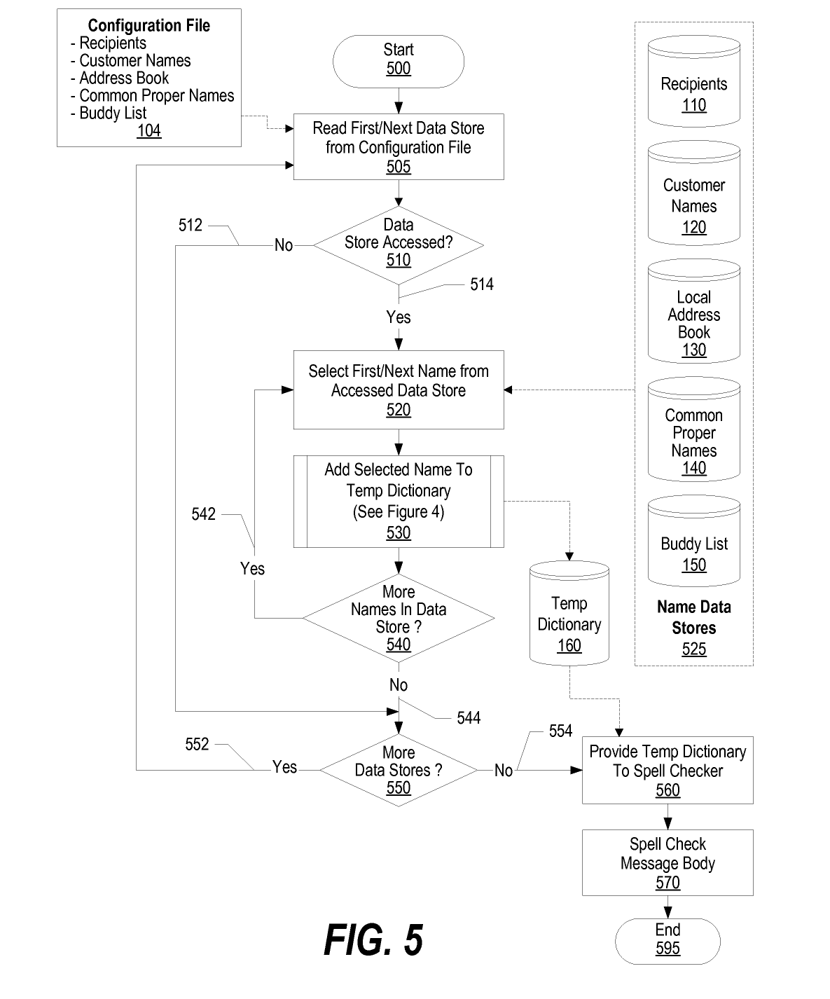

FIG. 5 is a flowchart showing another embodiment of steps taken for accessing the data stores to create the temporary dictionary. Spell check processing commences at 500, whereupon, at step 505, processing identifies a first data store that has been selected and stored in configuration file 104.

After reading the first data store from configuration file 104, a determination is made as to whether the first data store is available (decision 510). If the data store is available, decision 510 branches to “yes” branch 514 whereupon, at step 520, a first name is selected from the first accessed data store.

Available data stores are represented by name data stores 525. Those of ordinary skill in the art will appreciate that the name data stores 525 may include more data stores than the illustrated recipients data store 110, customer names data store 120, local address book data store 130, common proper names data store 140, and buddy list data store 150.

Following the selection of the first name from the first data store at step 520, the selected name is added to temporary dictionary 160 (predefined process 530, see FIG. 4 and corresponding text for processing details). After adding the selected name to the temporary dictionary 160, a determination is made as to whether more names exist in the selected data store (decision 540). If more names exist in the data store, decision 540 branches to “yes” branch 542 which loops back to process the next name from the data store. This looping continues until all names in the selected data store have been processed, at which time decision 540 branches to “no” branch 544.

A determination is made as to whether there are more data stores to process (decision 550). If there are more data stores to process, decision 550 branches to “yes” branch 552 which loops back to process the next data store. This looping continues until all data stores have been processed, at which time decision 550 branches to “no” branch 554.

After all data stores have been processed and decision 550 has branched to “no” branch 554, at step 560 processing provides temporary dictionary 160 to the spell checker and, at step 570, the message body is checked for spelling errors by the spell checker which uses a standard dictionary in addition to temporary dictionary 160 to check for misspelled words. The spell checker informs the user of misspelled words found in the email message body. When spell checking has completed, processing ends at 595.

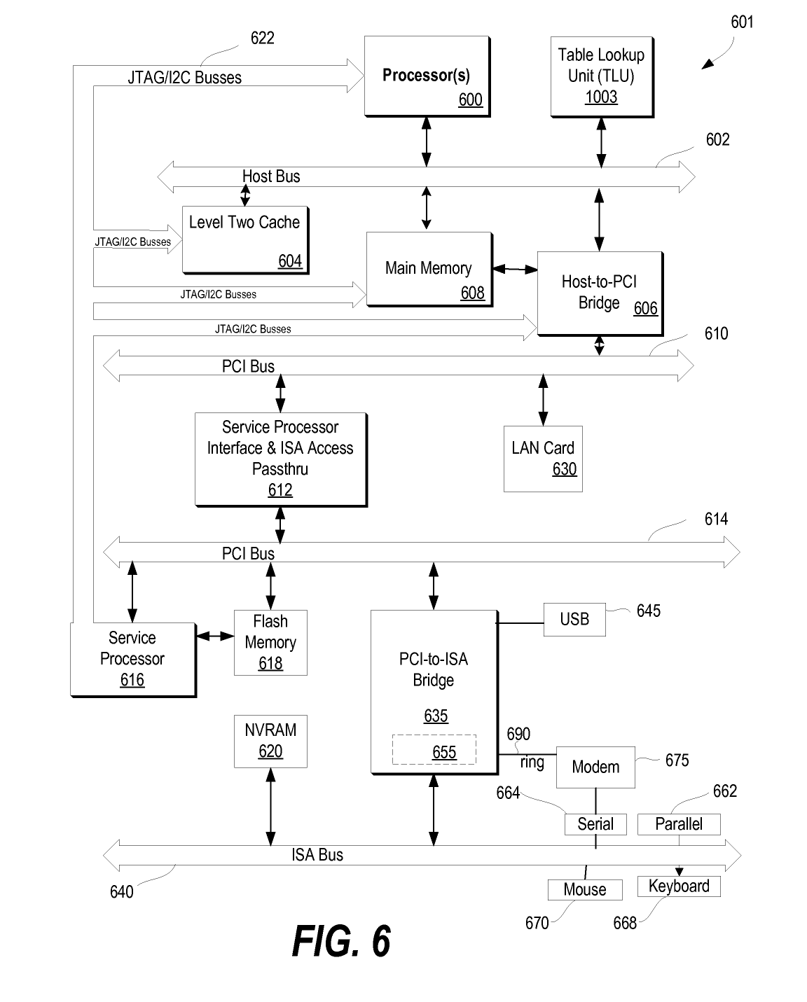

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a software program, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
retrieving one or more proper names from one or more data sources, wherein at least one of the data sources is an address book;
spell checking a body of an email message, the spell checking including:
comparing a plurality of words in the email body to a plurality of correctly spelled words, wherein, the plurality of correctly spelled words includes the retrieved proper names; and
reporting any misspelled words in the email body based on the comparing.

2. The method of claim 1 further comprising:
retrieving email addresses from the one or more data sources; and
prior to the comparing, including the retrieved email addresses in the plurality of correctly spelled words.

3. The method of claim 1 wherein at least one of the data sources is selected from the group consisting of a buddy list, an instant messaging list, an email recipient area included in the email message, a list of common proper names, and a customer names list.

4. The method of claim 1 further comprising:
forming a temporary data store that includes the proper names to be accessed when spell checking the body of the email message, wherein the spell checking includes using the words stored in the temporary data store to perform the comparing of the plurality of words in the body of the email with the plurality of correctly spelled words.

5. The method of claim 1 further comprising:
retrieving one or more settings of a configuration file, wherein each of the settings corresponds to one of the data sources;
accessing the data sources based on the retrieved configuration file settings, for each of the accessed data sources:
adding words from the accessed data source to a temporary data store, wherein at least one of the words is a proper name;
providing the temporary data store to a spell check process; and
after the spell checking, discarding the temporary data store.

6. The method of claim 5 wherein at least one of the data sources is accessed over a network.

7. The method of claim 1 further comprising:
retrieving one or more settings of a configuration file, wherein each of the settings corresponds to one of the data sources;
accessing one or more of the data sources based on the retrieved configuration file settings, wherein at least one of the data sources is accessed over a network, and wherein at least one of the data sources is selected from the group consisting of a buddy list, an instant messaging list, an email recipient area of the email message, a list of common proper names, and a customer names list, wherein, the accessing includes:
adding at least one word from the accessed data source to a temporary data store, wherein the added word is selected from the group consisting of a proper name and an email address;
providing the temporary data store to a spell check process, wherein the plurality of correctly spelled words includes the words included in the temporary data store; and
after the spell checking, discarding the temporary data store.

8. An information handling system comprising:
one or more processors;
a memory accessible by at least one of the processors;
a nonvolatile storage area accessible by at least one of the processors;
a network interface that connects the information handling system to a computer network, the network interface being accessible by at least one of the processors; and
a set of instructions stored in the memory, wherein one or more of the processors executes the set of instructions in order to perform actions of:
retrieving one or more proper names from one or more data sources, wherein at least one of the data sources is an address book;
spell checking a body of an email message, the spell checking including:
comparing a plurality of words in the email body to a plurality of correctly spelled words, wherein, the plurality of correctly spelled words includes the retrieved proper names; and
reporting any misspelled words in the email body based on the comparing.

9. The information handling system of claim 8 further comprising an additional set of instructions in order to perform actions of:
retrieving email addresses from the one or more data sources; and
prior to the comparing, including the retrieved email addresses in the plurality of correctly spelled words.

10. The information handling system of claim 8 wherein at least one of the data sources is selected from the group consisting of a buddy list, an instant messaging list, an email recipient area of the email message, a list of common proper names, and a customer names list.

11. The information handling system of claim 8 further comprising an additional set of instructions in order to perform actions of:
forming a temporary data store that includes the proper names to be accessed when spell checking the body of the email message, wherein the spell checking includes using the words stored in the temporary data store to perform the comparing of the plurality of words in the body of the email with the plurality of correctly spelled words.

12. The information handling system of claim 8 further comprising an additional set of instructions in order to perform actions of:
retrieving one or more settings of a configuration file, wherein each of the settings corresponds to one of the data sources;
accessing the data sources based on the retrieved configuration file settings, for each of the accessed data sources:
adding words from the accessed data source to a temporary data store, wherein at least one of the words is a proper name;
providing the temporary data store to a spell check process; and
after the spell checking, discarding the temporary data store.

13. The information handling system of claim 8 further comprising an additional set of instructions in order to perform actions of:
retrieving one or more settings of a configuration file, wherein each of the settings corresponds to one of the data sources;
accessing one or more of the data sources based on the retrieved configuration file settings, wherein at least one of the data sources is accessed over a network, and wherein at least one of the data sources is selected from the group consisting of a buddy list, an instant messaging list, an address book, a list of common proper names, and a customer names list, wherein, the accessing includes:
adding at least one word from the accessed data source to a temporary data store, wherein the added word is selected from the group consisting of a proper name and an email address;
providing the temporary data store to a spell check process, wherein the plurality of correctly spelled words includes the words included in the temporary data store; and
after the spell checking, discarding the temporary data store.

14. A computer program product stored in a computer readable medium, comprising functional descriptive material that, when executed by a data processing system, causes the data processing system to perform actions that include:
retrieving one or more proper names from one or more data sources, wherein at least one of the data sources is an address book;
spell checking a body of an email message, the spell checking including:
comparing a plurality of words in the email body to a plurality of correctly spelled words, wherein, the plurality of correctly spelled words includes the retrieved proper names; and
reporting any misspelled words in the email body based on the comparing.

15. The computer program product of claim 14 further comprising functional descriptive material that, when executed by a data processing system, causes the data processing system to perform actions that include:
retrieving email addresses from the one or more data sources; and
prior to the comparing, including the retrieved email addresses in the plurality of correctly spelled words.

16. The computer program product of claim 14 wherein at least one of the data sources is selected from the group consisting of a buddy list, an instant messaging list, an email recipient area of the email message, a list of common proper names, and a customer names list.

17. The computer program product of claim 14 further comprising functional descriptive material that, when executed by a data processing system, causes the data processing system to perform actions that include:
forming a temporary data store that includes the proper names to be accessed when spell checking the body of the email message, wherein the spell checking includes using the words stored in the temporary data store to perform the comparing of the plurality of words in the body of the email with the plurality of correctly spelled words.

18. The computer program product of claim 14 further comprising functional descriptive material that, when executed by a data processing system, causes the data processing system to perform actions that include:
retrieving one or more settings of a configuration file, wherein each of the settings corresponds to one of the data sources;
accessing the data sources based on the retrieved configuration file settings, for each of the accessed data sources:
adding words from the accessed data source to a temporary data store, wherein at least one of the words is a proper name;
providing the temporary data store to a spell check process; and
after the spell checking, discarding the temporary data store.

19. The computer program product of claim 18 wherein at least one of the data sources is accessed over a network.

20. The computer program product of claim 14 further comprising functional descriptive material that, when executed by a data processing system, causes the data processing system to perform actions that include:
retrieving one or more settings of a configuration file, wherein each of the settings corresponds to one of the data sources;
accessing one or more of the data sources based on the retrieved configuration file settings, wherein at least one of the data sources is accessed over a network, and wherein at least one of the data sources is selected from the group consisting of a buddy list, an instant messaging list, an email recipient area included in the email message, a list of common proper names, and a customer names list, wherein, the accessing includes:
adding at least one word from the accessed data source to a temporary data store, wherein the added word is selected from the group consisting of a proper name and an email address;
providing the temporary data store to a spell check process, wherein the plurality of correctly spelled words includes the words included in the temporary data store; and
after the spell checking, discarding the temporary data store.
